(19) United States
(12) Patent Application Publication
(10) Pub. No.: US 2022/0273130 A1
(43) Pub. Date: Sep. 1, 2022

(54) REUSABLE FILTER CARTRIDGE

(71) Applicant: Eko Brands, LLC, Woodinville, WA (US)

(72) Inventors: Ronald Ralph DeMiglio, Sun City West, AZ (US); John Frederick Kruger, JR., Clyde Hill, WA (US); Jennifer Shannon Lemmer, Seattle, WA (US); Ralph Wegener Satterlee, Seattle, WA (US)

(21) Appl. No.: 17/187,599

(22) Filed: Feb. 26, 2021

(51) Int. Cl. A47J 31/06

(52) U.S. Cl. CPC A47J 31/0689

(57) ABSTRACT

A beverage brewing device is configured for use with a beverage brewer having a plurality of inlet probes for dispensing water and an outlet probe positioned in a holster. A reusable cartridge includes a cup including a sidewall and a bottom wall, the bottom wall defining an outlet probe receptacle. A lid selectively secures to an upper rim of the sidewall with a twist lock mechanism. A cylinder on the lid includes inwardly extending tabs that seat within grooves on the upper rim and slide into circumferential grooves in the sidewall. The lid may include a central inlet probe receptacle and a plurality of perimeter inlet probe receptacles distributed around the central inlet probe receptacle.

### FIELD OF THE INVENTION

This application relates to cartridges for holding a brewing medium for use with an automated beverage brewer.

### BACKGROUND OF THE INVENTION

There are numerous devices available today for making a single-serve brewed beverage, such as the single-server brewers shown and described in, for example, U.S. Pat. Nos. 6,708,600, and 6,079,315, the disclosures of which are hereby expressly incorporated by reference herein.

In a typical single-serve beverage brewer, a disposable beverage filter cartridge containing a dry beverage medium (such as tea or coffee) is disposed within a filter cartridge holder or brewing holster. To brew the beverage, the filter cartridge is pierced by inlet and outlet probes to accommodate a through-flow of metered hot water. The hot water infuses the dry beverage medium contained in the cartridge to thereby produce a single serving of the beverage. After the beverage is brewed, the cartridge is removed from the cartridge holder and it is discarded.

By requiring the use of the disposable cartridges, the consumer is limited to the beverage selection of the cartridges on hand. Moreover, with each cartridge being disposed of after use, there is much needless waste. Thus there is a need for a reusable cartridge filter suitable for use with a beverage brewer described above that can be used with any desired dry beverage medium (coffee, tea, etc.).

The apparatus and methods disclosed herein provide an improved approach for preparing brewed beverages using a beverage brewer designed to use disposable cartridges.

### SUMMARY OF THE INVENTION

In one aspect of the invention, a beverage brewing cartridge includes: a bottom having a bottom perimeter, the bottom having an inner bottom surface and an outer bottom surface opposite the inner bottom surface; a sidewall including an inner sidewall surface and an outer sidewall surface, the sidewall extending upwardly and outwardly from the bottom perimeter to an upper rim, the upper rim defining a top opening, the bottom and the sidewall combining to define an interior space; a lid defining an inlet probe opening extending through the lid, the lid being moveable between an open position and a closed position, the lid further being sized to cover the top opening when in the closed position, the lid defining a central inlet probe opening and a plurality of perimeter inlet probe openings distributed around the central inlet probe opening; a receptacle indentation positioned at the bottom perimeter and being formed in a portion of the bottom and a portion of the sidewall, the receptacle indentation extending upwardly from the inner bottom surface and inwardly from the inner sidewall surface, the receptacle indentation forming a first interior receptacle indentation wall protruding into the interior space and being surrounded by the inner bottom surface and the inner sidewall surface; and one or more filter areas defined in the sidewall; and wherein the inner sidewall surface, the first interior receptacle indentation wall, the inner bottom surface, and the one or more filter areas are configured to combine to hold a brewing material when the brewing material is placed in the interior space.

In some embodiments, the upper rim defines one or more notches and one or more circumferential grooves extending around the outer sidewall surface; and the lid defines one or more inwardly protruding tabs configured to insert within the one or more notches and slide into the one or more circumferential grooves. In some embodiments, the lid includes a cylindrical surface, the inwardly protruding tabs being formed on the cylindrical surface.

In some embodiments, the receptacle indentation extends partially toward the center of the bottom surface.

In some embodiments, the sidewall is integrally formed with the bottom and the receptacle indentation is integrally formed with the bottom and the sidewall. In some embodiments, the one or more filter areas are included in the sidewall. In some embodiments, the one or more filter areas include mesh secured across filter openings in the sidewall. In some embodiments, the filter openings include two or more rows of filter openings, each row of the two or more rows of filter openings including a plurality of filter openings distributed circumferentially around the sidewall. In some embodiments, the lid includes a plurality of indentations around a perimeter of the lid.

In another aspect of the invention, a beverage brewing cartridge includes a lid defining an inlet probe opening and one or more first twist-lock features; a body comprising: a sidewall having a circular upper rim for engagement with the lid in the closed position, a lower edge defining a lower perimeter, and an inner sidewall surface extending between the upper rim and the lower edge and an outer sidewall surface extending between the upper rim and the lower edge, the sidewall defining one or more second twist-lock features configured to engage the first twist lock features; a bottom wall having an inner bottom surface and an outer bottom surface opposite the inner bottom surface, the bottom wall extending across the lower perimeter such that the inner bottom surface intersects the inner sidewall surface, the inner sidewall surface and inner bottom surface combining to form an internal volume; and one or more filter areas defined in the body; wherein the sidewall, the bottom surface, the receptacle wall, and the one or more filter areas are configured to, in combination, retain a dry beverage medium within the internal volume.

In some embodiments, the one or more first twist-lock features include one or more tabs secures to the lid. In some embodiments, the one or more second twist-lock features include: one or more notches extending into the sidewall from the upper rim and sized to receive the one or more tabs; and one or more circumferential grooves extending around the sidewall from the one or more notches and positioned to receive the one or more tabs responsive to rotation of the lid with the tabs positioned within the one or more notches. In some embodiments, a cylindrical surface is defined by the lid, the one or more tabs extending inwardly from the cylindrical surface. In some embodiments, the one or more circumferential grooves extend inwardly from the outer sidewall surface.

In some embodiments, an outlet probe receptacle extends inwardly from the inner sidewall surface and inwardly into the bottom surface toward a center of the bottom surface, the outlet probe receptacle further having a receptacle wall configured as an indentation extending into the internal volume.

In some embodiments, the lid defines a plurality of perimeter inlet probe openings distributed around the inlet probe opening. In some embodiments, the one or more filter areas are defined in the sidewall. The one or more filter areas may include mesh secured across filter openings in the sidewall. The filter openings may include two or more rows of filter openings, each row of the two or more rows of filter openings including a plurality of filter openings distributed circumferentially around the sidewall. The lid may include a plurality of indentations around a perimeter of the lid.

### BRIEF DESCRIPTION OF THE DRAWINGS

Preferred and alternative examples of the present invention are described in detail below with reference to the following drawings:

FIG. 1 is an isometric view of a reusable brewing device in accordance with an embodiment of the present invention;

FIG. 2 is a lower isometric view of the reusable brewing device;

FIG. 3A is a top isometric view of the interior of the reusable brewing device in accordance with an embodiment of the present invention;

FIG. 3B is a top isometric view of the interior of an alternative embodiment of the reusable brewing device in accordance with an embodiment of the present invention;

FIG. 4 is a top view of a lid for the reusable brewing device in accordance with an embodiment of the present invention;

FIG. 5 is a top view of an alternative embodiment of a lid for the reusable brewing device in accordance with an embodiment of the present invention;

FIG. 6 is an isometric view of a lower side of the lid of FIG. 4;

FIG. 7 is an isometric view of a lower side of the lid of FIG. 5;

FIG. 8A is a partial isometric view of locking structures on a cup in accordance with an embodiment of the present invention; and

FIG. 8B is a partial isometric view of locking structures on a lid in accordance with an embodiment of the present invention.

### DETAILED DESCRIPTION OF THE PREFERRED EMBODIMENT

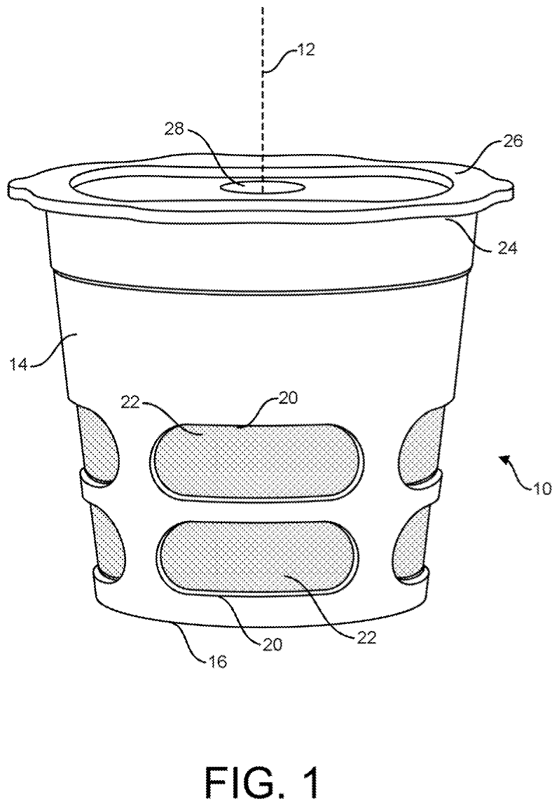

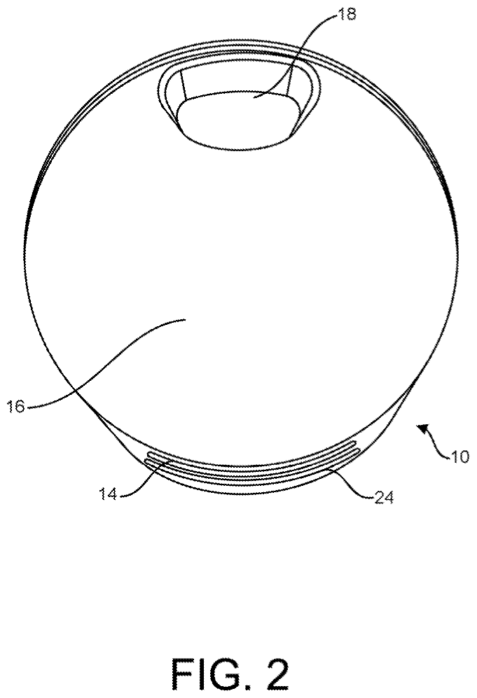

Referring to FIGS. 1, 2, 3A, and 3B, a reusable filter cartridge includes a base cup 10 defining an axis of symmetry 12 about which a sidewall 14 of the base cup 10 is generally symmetrical with various non-symmetrical features defined thereon. The sidewall 14 has a generally conical shape with a shallow tapering to conform to a holster of a beverage brewing device. A bottom wall 16 extends inwardly from the sidewall 14 such that some or all of the sidewall 14 extends above an inner bottom surface of the bottom wall 16. The bottom wall 16 may define an outer bottom surface opposite the inner bottom surface and both may be at least partially planar. The inner bottom surface may include a planar portion extending from a first location at a perimeter of the bottom wall 16 to a second location at the perimeter, the first location being diametrically opposite the second location

One or more outlet probe receptacles 18 protrude inwardly from one or both of the sidewall 14 and the bottom wall 16. In the illustrated embodiment, one outlet probe receptacles 18 protrude upwardly through the bottom wall 16. In other embodiments, two outlet probe receptacles are disposed 180 degrees apart about the axis of symmetry 12. The outlet probe receptacle 18 may include a pocket made of continuous, imperforated, impermeable material (e.g., the same material as the base cup) that isolate the contents of the base cup 10 from an outlet probe protruding into the outlet probe receptacle. In other embodiments, the receptacle 18 may include one or more perforations. In a typical beverage brewer, only one outlet probe is present such that only one receptacle 18 is used in some embodiments. However, providing two receptacles 18 enables the user to position the base cup in two positions without interference from the outlet probe.

In the illustrated embodiment, the receptacles 18 are embodied as indentations positioned inwardly from a bottom perimeter of the sidewall and formed by a portion of the bottom wall 16 and a portion of the sidewall. The indentation of each receptacle 18 may extend upwardly from the inner bottom surface of the bottom wall 16 and inwardly from an inner sidewall surface of the sidewall 14. The receptacle 18 may include a first interior receptacle indentation wall protruding into an interior space defined by the sidewall 14 and bottom wall 16 and be surrounded by the inner bottom surface and the inner sidewall surface. As is apparent in FIGS. 1-3B, the sidewall 14, bottom wall 16, and receptacles 18 may be integrally formed, e.g., co-molded.

The sidewall 14 further defines one or more filter apertures 20. The filter apertures 20 may be large and occupy a major portion (e.g., between 20 and 50 percent) of the vertical (e.g., parallel to the axis of symmetry 12) and circumferential (e.g., about the axis of symmetry 12) extent of the sidewall 14 between the topmost and bottommost edges thereof.

In the illustrated embodiment, there are two rows of filter apertures 20 in the sidewall 14. In the illustrated embodiment, each aperture 20 includes a straight top edge, straight bottom edge, and rounded end portions extending between the straight top edge and straight bottom edge. In the illustrated embodiment, each row includes three filter apertures 20 distributed circumferentially about the axis or symmetry 12 around the sidewall 14. For example, in the embodiment shown in FIG. 1, the opposite (facing away from the viewer) side of the cup 10 may have an identical configuration of the filter apertures 20 except that the central aperture 20 shown in FIG. 1 would be absent. In some embodiments, there are four apertures 20 in each row distributed uniformly around the sidewall 14. In some embodiments, there may be one row of filter apertures 20 or three or more rows of filter apertures 20.

The filter apertures 20 are completely covered by filter material 22. Any suitable reusable, durable filter may be used, such as a micro-screen mesh filter made from metal (such as gold or stainless steel, gold-tone filters), plastic, or fabric. The filter material 22 may be molded into the material of the sidewall 14 in order to resist separation from the sidewall 14 after repeated use. Filter material 22 may include a plurality of perforations in the sidewall 14.

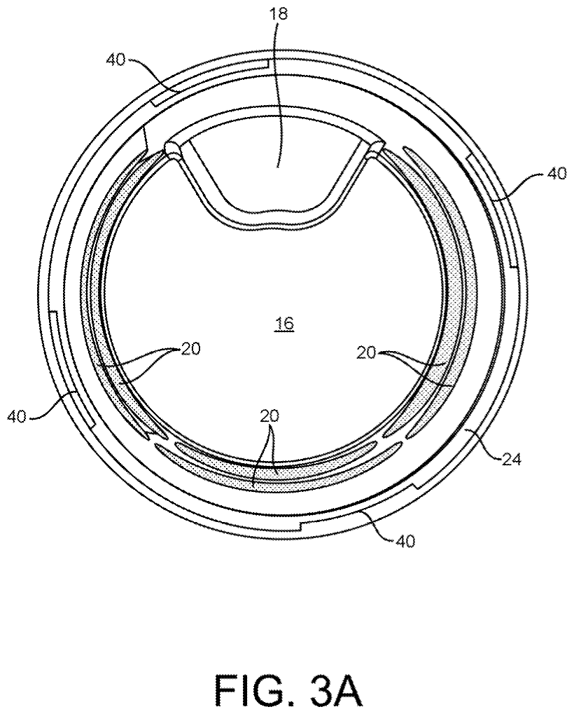

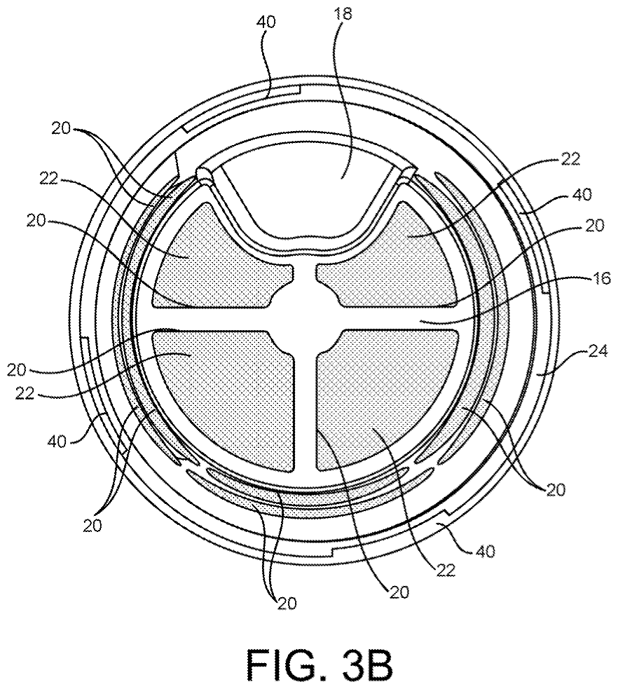

The bottom wall 16 may be continuous piece of material or may include perforations functioning as filter material or may include additional openings 20 covered by filter material 22. In the embodiment of FIG. 3A, the bottom wall 16 lacks filter apertures 20 and corresponding filter material 22. In the embodiment of FIG. 3B, the bottom wall 16 defines one or more filter apertures 20 covered in filter material 22.

An upper rim 24 of the sidewall 14 may include a fastening structure such as threads, a snap-type fitting, or any other type of fastening structure. The filter cartridge further includes a lid 26 that selectively engages the upper rim 24. The lid 26 defines an inlet probe receptacle 28 for receiving the inlet probe of a brewing device. The lid 24, sidewall 14, and bottom wall 16 define a brewing chamber for holding a dry beverage medium.

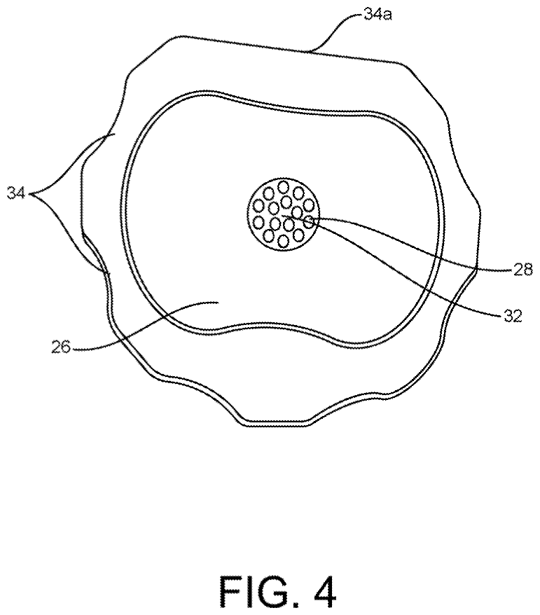

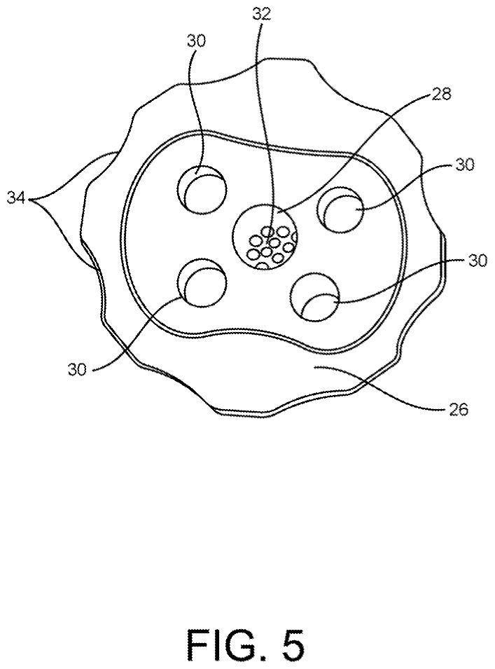

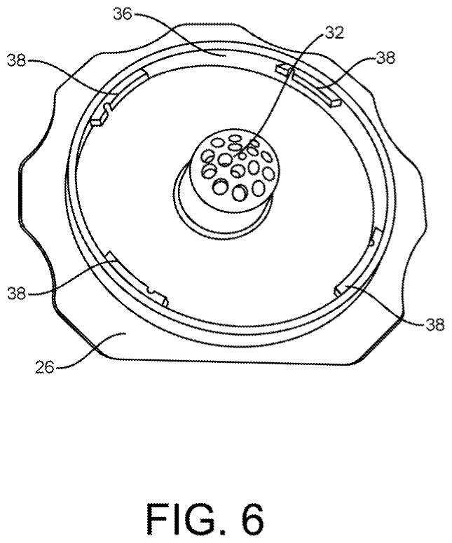

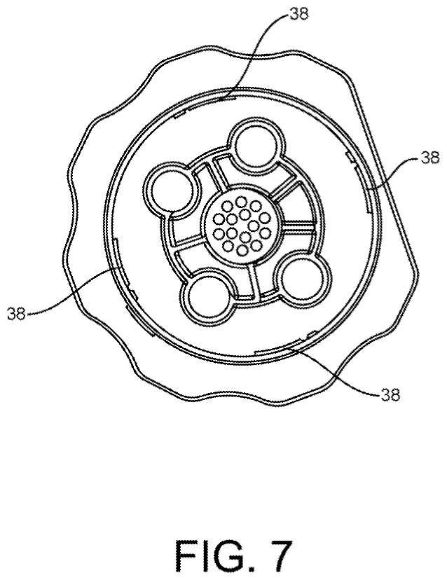

Referring to FIGS. 4 and 6, in some embodiments the lid 26 has one inlet probe receptacle 28 that may be located at a center of the lid 26, e.g. be intersected by the axis of symmetry 12. Referring to FIGS. 5 and 7, in other embodiments, there may be additional inlet probe receptacles 30 passing through the lid and distributed around the inlet probe receptacle 28. The inlet probe receptacles 30 may be uniformly or non-uniformly distributed about the inlet probe receptacle 28. The inlet probe receptacles 30 may be the same size as the receptacle 28 or different sizes. In the illustrated embodiment, the inlet probe receptacles 30 are equidistant from the inlet probe receptacle but other arrangements may also be used. In the illustrated embodiment, there are four inlet probe receptacles 30. However, other numbers of openings may be present, such as two, three, or five or more.

In the illustrated embodiment, a distributor 32 is positioned on an underside of the lid 24 over the receptacle 28. The distributor 32 may include a conical member with the point of the conical member pointed downward when the lid 26 is positioned on the rim 24. The conical portion may include a plurality of openings to distribute fluid dispensed into the inlet probe receptacle 28. The conical portion may be connected to the lid 26 by means of a cylinder that may include or omit additional openings. Distributors 32 may be positioned under the receptacles 30 or may be omitted.

The perimeter of the lid 26 may include indentations 34 distributed around the entirety of the lid 26 as shown in FIG. 5 or around a portion of the lid 26 (e.g., an arc of 180 to 270 degrees) as shown in FIG. 4. For example, arcuate indentations 34 with a depth of 1 to 4 mm and each occupying an angular region of 20 to 50 degrees about the axis of symmetry 12 may be used. In the illustrated embodiment, there are eight indentations 34. However, other numbers of indentations 34 such as 6 to 10 may also be used. The perimeter of the lid 26 may include a flattened portion 34a, such as occupying an angular region of 70 to 120 degrees about the center of the lid 26. The flattened portion 34a may provide clearance for structures of a brewing device in which cup 10 and lid 26 are used.

Referring to FIGS. 3A, 3B, 6, 7, 8A, and 8B, a twist-lock mechanism may be used to secure the lid 26 to the cup 10. For example, an inward facing cylindrical surface 36 may be defined on an underside of the lid 26 and one or more tabs 38 may protrude inwardly from the cylindrical surface 36. The rim 24 of the cup 10 may define one or more notches 40 and circumferential outer grooves 42 may extend from each notch 40 either or completely or partially to an adjacent notch 40. The tabs 38 may be placed in the notches 40 and the lid 26 may then be rotated to urge the one or more tabs 38 into the one or more grooves 42 in order to secure the lid 26 to the cup 10. Friction between the tabs 38 and the grooves 42 may facilitate securement of the lid 26 to the cup 10. The twist-lock mechanism may advantageously eliminate use of an o-ring between the lid 26 and the cup 10. For example, the cylindrical surface 36 may engage the sidewall 14 such that escape of brewing material is sufficiently hindered.

In the illustrated embodiment, there are four tabs 38 and four notches 40 distributed uniformly about the axis of symmetry 12 on the lid 26 and rim 24, respectively. Other numbers of tabs 38 and notches 40 may be used and their distribution may be non-uniform. Tabs 38 may extend outwardly from the rim 24 and the cylindrical surface 36 may define the notches 40 and grooves 42 for receiving the tabs 38.

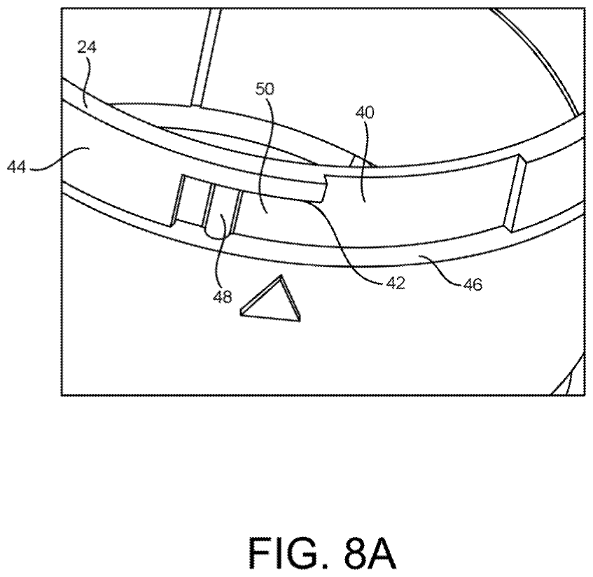

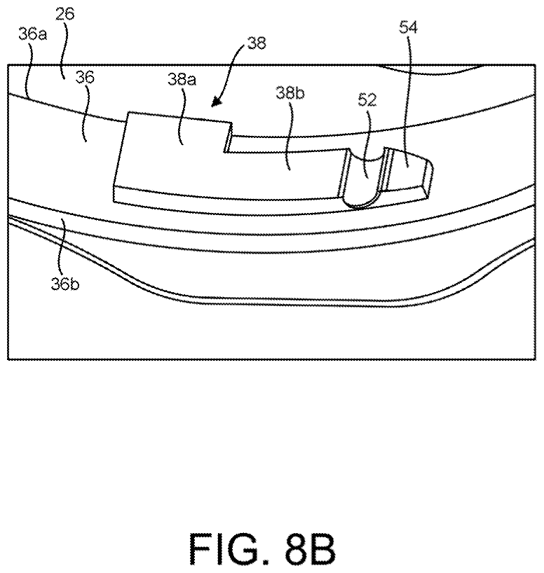

FIG. 8A is a detailed view of a notch 40 and groove 42. The groove 42 may extend inwardly from a surface 44, such as a cylindrical surface 44, below the rim 24 of the sidewall 14. The surface 44 may extend from the rim 24 to a widened portion of the sidewall 14 such that a shoulder 46 extends outwardly perpendicular to the axis of symmetry from the surface 44. The bottom of the cylindrical surface 36 may rest on the shoulder 46 when secured to the sidewall 14. In the illustrated embodiment, a protrusion 48 extends into the groove 42 from an inner surface 50 of the groove 42, the inner surface 50 may be cylindrical and centered on the axis of symmetry 12 and may be continuous (same cylinder) as the inner surface of the notch 40. The protrusion 48 may extend completely or partially to a cylinder conforming to the surface 44. In the illustrated embodiment, the protrusion 48 conforms to a portion of a cylinder with its axis of symmetry parallel to the axis of symmetry 12.

Referring to FIG. 8B, the tab 38 may include a first portion 38a that extends downwardly from the top 36a of the cylindrical portion 36. A second portion 38b extends circumferentially from the first portion 38a offset from the top 36a of the cylindrical portion and from the bottom 36b of the cylindrical portion. The second portion 38b may be sized to insert within the groove 42. The second portion 38b may define a notch 52 such that when the second portion 38b is positioned within the groove 42 the notch 52 is positioned over the protrusion 48 and both resists removal and provides tactile or audible feedback to the user indicating that the lid 26 is locked into place. The second portion 38b may include a tapered portion 54 to guide the second portion 38b into the groove 42. The first portion 38a may engage the sides of the notch 40 and limit rotation of the lid 26 relative to the sidewall 14 when pivoting between locked and unlocked positions.

In use, the cup 10 and lid 26 may be used by:
1. Placing brewing material in the cup 10.
2. Placing the lid 26 on the rim 24 of the cup 10 with tabs 38 positioned within the notches 40.
3. Turning the lid 26 to place tabs 38 within the grooves 42 (e.g., the second portion 38b within the notch 42 with the protrusion 48 positioned within the notch 52).
4. Placing the cup 10 and lid 26 into a holster of a brewing device with the outlet probe of the brewing device placed within one of the one or more outlet probe receptacles 18.
5. Closing a lid of the brewing device to insert a single inlet probe through the inlet probe receptacle 28 or insert a plurality of inlet probes into two or more of the inlet probe receptacle 28 and the inlet probe receptacles 30.
6. Emitting water through the inlet probe or probes onto the brewing material.
7. Passing water through the filter material 22 to the outlet probe.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A beverage brewing cartridge comprising:
a bottom having a bottom perimeter, the bottom having an inner bottom surface and an outer bottom surface opposite the inner bottom surface;
a sidewall including an inner sidewall surface and an outer sidewall surface, the sidewall extending upwardly and outwardly from the bottom perimeter to an upper rim, the upper rim defining a top opening, the bottom and the sidewall combining to define an interior space;
a lid defining an inlet probe opening extending through the lid, the lid being moveable between an open position and a closed position, the lid further being sized to cover the top opening when in the closed position, the lid defining a central inlet probe opening and a plurality of perimeter inlet probe openings distributed around the central inlet probe opening;
a receptacle indentation positioned at the bottom perimeter and being formed in a portion of the bottom and a portion of the sidewall, the receptacle indentation extending upwardly from the inner bottom surface and inwardly from the inner sidewall surface, the receptacle indentation forming a first interior receptacle indentation wall protruding into the interior space and being surrounded by the inner bottom surface and the inner sidewall surface; and
one or more filter areas defined in the sidewall;
wherein the inner sidewall surface, the first interior receptacle indentation wall, the inner bottom surface, and the one or more filter areas are configured to combine to hold a brewing material when the brewing material is placed in the interior space.

2. The beverage brewing cartridge of claim 1, wherein
the upper rim defines one or more notches and one or more circumferential grooves extending at least partially around the outer sidewall surface; and
the lid defines one or more inwardly protruding tabs configured to insert within the one or more notches and slide into the one or more circumferential grooves.

3. The beverage brewing cartridge of claim 2, wherein the lid includes a cylindrical surface, the inwardly protruding tabs being formed on the cylindrical surface.

4. The beverage brewing cartridge of claim 1, wherein the receptacle indentation extends partially toward the center of the bottom surface.

5. The beverage brewing cartridge of claim 1, wherein the sidewall is integrally formed with the bottom and the receptacle indentation is integrally formed with the bottom and the sidewall.

6. The beverage brewing cartridge of claim 1, wherein the one or more filter areas are included in the sidewall.

7. The beverage brewing cartridge of claim 1, wherein the one or more filter areas include mesh secured across filter openings in the sidewall.

8. The beverage brewing cartridge of claim 7, wherein the filter openings include two or more rows of filter openings, each row of the two or more rows of filter openings including a plurality of filter openings distributed circumferentially around the sidewall.

9. The beverage brewing cartridge of claim 1, wherein the lid comprises a plurality of indentations around a perimeter of the lid.

10. A beverage brewing cartridge comprising:
a lid defining an inlet probe opening and one or more first twist-lock features;
a body comprising:
a sidewall having a circular upper rim for engagement with the lid in the closed position, a lower edge defining a lower perimeter, and an inner sidewall surface extending between the upper rim and the lower edge and an outer sidewall surface extending between the upper rim and the lower edge, the sidewall defining one or more second twist-lock features configured to engage the first twist lock features;
a bottom wall having an inner bottom surface and an outer bottom surface opposite the inner bottom surface, the bottom surface extending across the lower perimeter such that the inner bottom surface intersects the inner sidewall surface, the inner sidewall surface and inner bottom surface combining to form an internal volume; and
one or more filter areas defined in the body;
wherein the sidewall, the bottom wall, the receptacle wall, and the one or more filter areas are configured to, in combination, retain a dry beverage medium within the internal volume.

11. The beverage brewing cartridge of claim 10, wherein the one or more first twist-lock features include one or more tabs secures to the lid.

12. The beverage brewing cartridge of claim 11, wherein the one or more second twist-lock features comprise:
one or more notches extending into the sidewall from the upper rim and sized to receive the one or more tabs; and
one or more circumferential grooves extending around the sidewall from the one or more notches and positioned to receive the one or more tabs responsive to rotation of the lid with the tabs positioned within the one or more notches.

13. The beverage brewing cartridge of claim 12, further comprising a cylindrical surface defined by the lid, the one or more tabs extending inwardly from the cylindrical surface.

14. The beverage brewing cartridge of claim 13, wherein the one or more circumferential grooves extend inwardly from the outer sidewall surface.

15. The beverage brewing cartridge of claim 10, further comprising an outlet probe receptacle extending inwardly from the inner sidewall surface and inwardly into the bottom wall toward a center of the bottom wall, the outlet probe receptacle further having a receptacle wall configured as an indentation extending into the internal volume.

16. The beverage brewing cartridge of claim 10, further comprising a plurality of perimeter inlet probe openings distributed around the inlet probe opening.

17. The beverage brewing cartridge of claim 10, wherein the one or more filter areas are defined in the sidewall.

18. The beverage brewing cartridge of claim 17, wherein the one or more filter areas include mesh secured across filter openings in the sidewall.

19. The beverage brewing cartridge of claim 18, wherein the filter openings include two or more rows of filter openings, each row of the two or more rows of filter openings including a plurality of filter openings distributed circumferentially around the sidewall.

20. The beverage brewing cartridge of claim 10, wherein the lid comprises a plurality of indentations around a perimeter of the lid.
